(19) United States
(12) Patent Application Publication
(10) Pub. No.: US 2006/0225795 A1
(43) Pub. Date: Oct. 12, 2006

(54) Push button regulator device with sealing element to facilitate easy connection with other devices

(76) Inventor: George D. Baker, Cambridge, MD (US)

Correspondence Address: Linda K. Russell;Air Liquide, Suite 1800, 2700 Post Oak Blvd., Houston, TX, 77056, US

(21) Appl. No.: 11/384,831

(22) Filed: Mar. 21, 2006

Related U.S. Application Data
(60) Provisional application No. 60/666,353, filed on Mar. 30, 2005.

(51) Int. Cl. F16K 31/06

(52) U.S. Cl. 137/614.19

(57) ABSTRACT

A regulator device includes a first valve member and a second valve member disposed within a housing of the device. The first valve member regulates the pressure of fluid exiting the device, and the second valve member is biased to a closed position and is opened by manipulation of an actuator. A sealing element is connected at the housing outlet and has a transverse cross-sectional dimension that decreases from an inlet of the sealing element to an outlet of the sealing element. In addition, a guard is provided that extends around a periphery of the actuator and includes a cut-out section to permit easy access to the actuator during use of the device.

### CROSS-REFERENCE TO RELATED APPLICATIONS

This application claims priority from U.S. Provisional Patent Application Serial No. 60/666,353, entitled “Top Push Button Regulator With Finger Cut Out and Conical Elastomeric Sealing Element for Introduction of Calibration Fases Into Analyzers,” and filed Mar. 30, 2005. The disclosure of this provisional patent application is incorporated herein by reference in its entirety.

### BACKGROUND OF INVENTION

1. Field of Invention

The present invention pertains to regulator valves for providing calibration gases to analyzers.

2. Related Art

Regulator devices are used for introducing fluids such as calibration gases into analyzers to render the analyzers effective for monitoring a particular chemical species. One problem associated with such regulators is that it can become cumbersome in switching between analyzers or in re-connecting with the same analyzer, since the outlet of the regulator must be connected in a fluid tight sealing arrangement at an inlet of an analyzer. Thus, it is difficult to easily maneuver from one analyzer to the next in operation of the regulator device.

### SUMMARY OF THE INVENTION

The present invention provides a portable, hand held regulator device that is easy to use and is configured to easily connect from one analyzer to another while ensuring a fluid tight connection is maintained at the connection.

In accordance with the present invention, a regulator device comprises a housing including an inlet that is securable to a fluid vessel so as to receive fluid within a channel of the housing from the fluid vessel and an outlet that delivers fluid from the regulator device. Disposed within the housing is a first valve member that maintains the fluid pressure delivered from the fluid vessel to the housing outlet within a selected pressure range, and a second valve member located between the first valve member and the housing outlet. The second valve member includes a biasing member that biases the second valve member in a closed position to prevent fluid from flowing through the second valve member to the housing outlet. An actuator (e.g., a button) is also provided that is selectively movable against the bias of the biasing member so as to open the second valve member and allow fluid to flow through the second valve member and to the housing outlet. The regulator device further includes a sealing element that is connected at the housing outlet and includes a channel extending through the sealing element. The sealing element has a transverse cross-sectional dimension that decreases from an inlet of the sealing element to an outlet of the sealing element.

The actuator is suitably dimensioned and aligned at an end of the housing so as to be movable by a thumb or finger of a user while the user holds the regulator device. The regulator device further comprises a guard that extends around a peripheral portion of the actuator. In a preferred embodiment, the guard includes a cut-out section to facilitate easy access to the actuator by insertion of the thumb or finger of the user through the cut-out section.

The improved regulator device of the present invention facilitates easy connection of the outlet of the regulator with a variety of different inlet designs and configurations for analyzers. In addition, the valve actuator is easy for the user to manipulate due to the cut-out section being provided at the actuator location on the valve.

The above and still further features and advantages of the present invention will become apparent upon consideration of the following detailed description of specific embodiments thereof, particularly when taken in conjunction with the accompanying drawings wherein like reference numerals in the figures are utilized to designate like components.

### BRIEF DESCRIPTION OF THE DRAWINGS

FIG. 1 is a cross-sectional side view of an exemplary embodiment of a regulator device in accordance with the present invention.

FIG. 2 is a side view in elevation of the regulator device of FIG. 1.

FIGS. 3A and 3B are a cross-sectional side views showing operation of the second valve of the regulator device of FIG. 1.

FIG. 4 is a view in perspective of an alternative embodiment of an elastomeric connector that can be used with a regulator device in accordance with the present invention.

FIG. 5 is a view in perspective of a further embodiment of an elastomeric connector that can be used with a regulator device in accordance with the present invention.

### DESCRIPTION OF PREFERRED EMBODIMENTS

In accordance with the present invention, a portable, hand-held regulator device is provided which renders the regulator device easy to use and manipulate and capable of connection with different analyzers with relative ease. In particular, the present invention provides the feature of an actuator (e.g., a button) for the regulator with an actuator guard that includes a cut-out or removed section to facilitate easy access to the actuator during use. In addition, the present invention provides the feature of a sealing connector that can be plastic and/or elastomeric and that has a conical, stepped and/or tapered outer surface to facilitate easy connection with analyzer inlets of varying dimensions and without the requirement of a fastener to ensure a fluid tight connection is achieved.

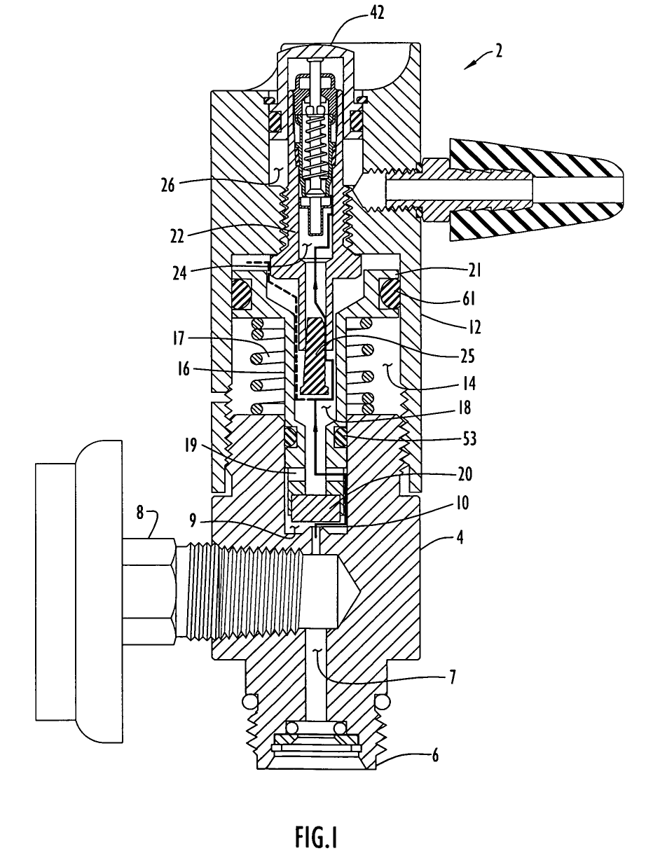

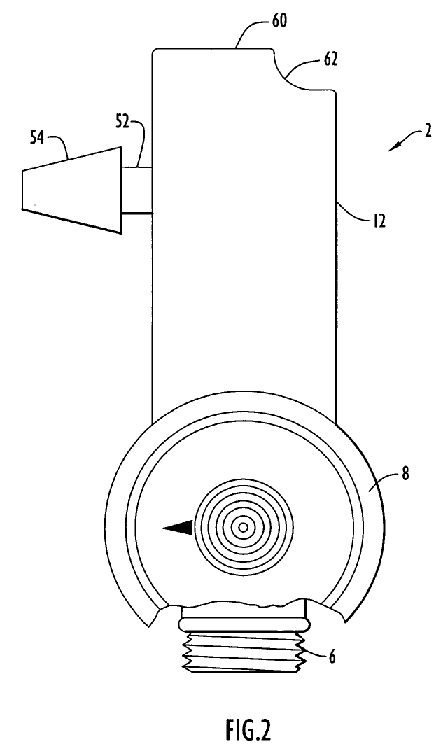

An exemplary embodiment of a regulator device that implements the features of the present invention is depicted in FIGS. 1-3. Referring to FIGS. 1 and 2, a regulator device 2 includes a lower housing 4 including an inlet section or port 6 that connects with a cylinder or vessel in a fluid tight sealing arrangement. In particular, inlet port 6 includes an externally or male threaded section that connects with a corresponding female threaded outlet port of a fluid vessel to facilitate fluid transfer from the fluid vessel into the regulator device. The inlet port of the regulator device can include any suitable sealing members, such as elastomeric O-rings (as shown in FIG. 1), to ensure a fluid tight connection is established and maintained between the regulator device and the fluid vessel during regulator operation. A channel 7 extends axially through lower housing 4 and provides a fluid passage from the lower housing to an upper housing 12 described below. Unless described otherwise herein, the upper housing and lower housing, as well as various other components of the regulator device, can be constructed of any suitable materials including, without limitation, metals (e.g., stainless steel) and alloys thereof (e.g., brass) and hard or soft plastic and/or polymer materials (e.g., polytetrafluoroethylene, elastomeric materials such as rubber, etc.).

A bore extends within the lower housing transversely from channel 7 to an external surface portion of the lower housing. A pressure gauge 8 is connected within the bore (e.g., via a threaded engagement) to provide an indication (e.g., a visual indication) of the fluid pressure within the fluid vessel to during regulator operation. Central channel 7 further includes an enlarged or widened section 9 that extends from a point located above the pressure gauge bore to an open upper end of the lower housing. A valve seat 10 is defined at the location where channel 7 enlarges to its widened section 9.

Upper housing 12 is connected with lower housing 4 via a suitable fluid tight connection (e.g., a threaded engagement as shown in FIG. 1). The upper housing 12 further includes a channel extending axially through the upper housing. The axially extending channel includes a valve chamber 14 located at a lower portion of the upper housing, a central portion that facilitates connection with a flow restriction member 22 described below, and an upper portion that extends to an open upper end of the upper housing and that is configured to receive a second valve member as described below. When upper housing 12 is secured to lower housing 4, valve chamber 14 extends to the upper end of the lower housing.

A movable member 16 is disposed within valve chamber 14 and is suitably dimensioned to be axially displaced with the valve chamber. The movable member includes a channel 18 extending axially through the member to upper and lower ends of the movable member. Member 16 has a generally T-shaped cross-sectional configuration, with an enlarged upper end 21 and a narrower lower end, and channel 18 also widens at a location corresponding with the enlarged upper end. The movable member is further biased toward an upper end of the valve chamber via a coil spring 17, where the coil spring engages with the upper end surface of lower housing 4 and a lower surface of the enlarged upper end 21 of member 16. The enlarged upper end of member 16 has a cross-sectional dimension that is slightly smaller than the cross-sectional dimension of valve chamber 14, and an elastomeric O-ring 61 is provided within an outer peripheral groove of the enlarged upper end. The O-ring engages with the interior walls of chamber 14 to provide a fluid tight seal between the enlarged upper end of movable member 16 and the interior chamber walls during movement the movable member as described below.

The lower end of movable member 16 extends within widened section 9 of the lower housing channel. The transverse cross-sectional dimension of the lower end of member 16 is slightly smaller than the transverse cross-sectional dimension of widened section 9 so as to permit axial movement of the lower end within this widened section. An end cap 20 is secured to the lower end of member 16 so as to prevent fluid from flowing through the lower end and into channel 18 of the movable member. End cap 20 is further configured to engage with lower housing valve seat 10 when the movable member is displaced toward the seat due to fluid pressure within valve chamber 14 as described below. Two channels or inlets 19 are disposed near the lower end of movable member 16 just above and proximate end cap 20. Inlets 19 extend transversely from channel 18 to outer surface portions of member 16 so as to provide a fluid flow path between widened section 9 of the lower housing and the movable member channel. An elastomeric O-ring 53 is provided around the movable member at a location just above and proximate inlets 19 so as to provide a fluid tight seal that prevents fluid flow from widened section 9 directly into valve chamber 14.

A flow restriction member 22 is secured within the channel of upper housing 12 to restrict fluid flow through the upper housing in a manner as described below. In particular, flow restriction member 22 is secured within the upper housing via a threaded engagement located at the central portion of the upper housing channel (which is located above valve chamber 14) so as to provide a fluid tight seal at such threaded engagement. Flow restriction member 22 includes a narrow lower section with an open lower end that extends within valve chamber 14 and also within channel 18 of movable member 16. The upper portion of member 22 is disposed within the upper portion of the axially extending channel of upper housing 12 and includes an open upper end that extends to the open upper end of the upper housing. The upper end of the flow restriction member is also smaller in transverse cross-sectional dimension than the transverse cross-sectional dimension of the upper portion of the upper housing channel, such that an annular fluid flow passage 26 is defined at this location.

An axially extending channel 24 is defined within and extends between the two open ends of flow restriction member 22. In addition, a plug 25 is fit within the lower open end of member 22. The plug is preferably formed of a suitable plastic or polymer material (e.g., an elastomeric material) and is configured to partially close but not completely seal the lower open end of member 22, thus defining a restricted fluid flow passage between channel 18 of the movable member and channel 24 of the flow restriction member. The combination of the valve chamber, the movable member and the flow restriction member within the regulator device operate as a first regulating valve member in a manner described below so as to deliver fluid at a selected pressure into the upper portion of the flow restriction member and to an outlet of the regulator device.

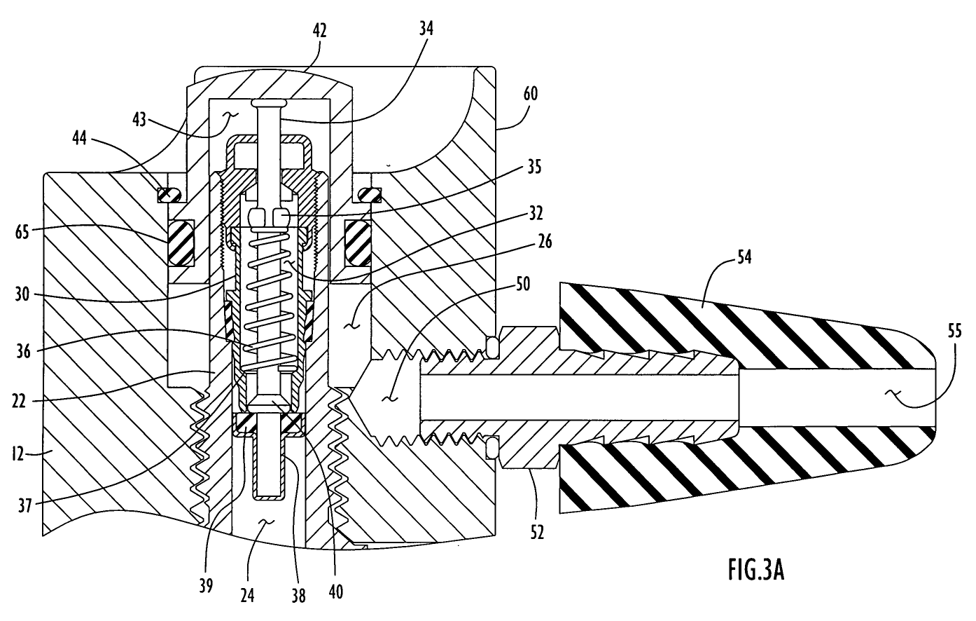

A second valve member is partially secured within the upper portion of flow restriction member 22 (e.g., via a threaded engagement) and is operable by user manipulation as described below to permit fluid flow through the second valve member to the regulator outlet. Referring to FIGS. 3A and 3B, the second valve member includes a valve core 30 having an axially extending channel 32 extending between the two open and opposing ends of the valve core and a pin 34 that is axially movable within channel 32. The valve core is secured within the flow restriction member in a fluid tight fitting relationship so as to prevent fluid flow between respective outer and inner wall portions of the valve core and the flow restriction member.

The movable pin extends from both ends of the valve core. A coil spring 36 is also disposed within channel 32 and is configured to bias pin 34 in a direction toward the upper end of valve core 30. In particular, an upper end of spring 36 engages with an outwardly extending annular member 35 defined at an upper location on pin 34, while a lower end of spring 36 engages with a ledge 37 disposed within channel 32 at a location proximate the lower end of the valve core. A spring tension exists within the spring to force both pin 34 and annular member 35 of the pin toward the open upper end of the valve core.

A cup 38 is secured around the lower end of pin 34 which extends through the lower end opening of valve core 30. The cup has a generally T-shaped cross-sectional configuration, with an elongated lower section to receive the lower end of pin 34 and a widened upper section aligned with the lower end of valve core 30 and that includes an elastomeric or rubber sealing member 39 secured within the widened upper section. Sealing member 39 has an annular configuration and is suitably dimensioned to fit snugly around pin 34. In addition, due to the bias of spring 36 on pin 34, the widened upper section of cup 38 and sealing member 39 are forced against the lower open end of the valve core so as to establish a fluid tight seal that prevents fluid from entering this open end. The pin and cup are moved away from the lower end of valve core 30 in a manner described below to facilitate opening of the valve core at its lower end during operation of the second valve. Pin 34 also includes an outwardly extending annular member 40 that is disposed directly above cup 38 and is further configured to engage with sealing member 39 so as to ensure movement of the cup and the sealing member with the pin during opening of the second valve.

An actuator 42 is provided to engage the upper end of pin 34 that extends from the valve core upper end. The actuator is configured as a button that can be depressed by a user to move the pin in a direction toward the lower open end of valve core 30 so as to open the second valve in the manner described below. Actuator 42 has a generally U-shaped cross-sectional configuration and extends over the open upper ends of valve core 30 and flow restriction member 22 to define a fluid flow chamber 43 by which fluid can flow from the second valve into chamber 43 and then into annular chamber 26 as described below.

The actuator is secured in a fluid tight sealing engagement with upper housing 12 (e.g., utilizing an elastomeric O-ring 65 as shown in FIG. 1) which facilitates axial movement of the actuator within the upper housing while preventing fluid from flowing from the open upper end of the upper housing. The bias applied to pin 34 by spring 36 is also applied to actuator 42. However, the actuator is prevented from being forced completely from the housing by a locking member 44 that extends radially inward from interior wall surface portions at the upper end of the upper housing to engage with an enlarged lower end portion of the actuator. A narrow fluid passage is also defined between the portion of the actuator that extends around the open upper ends of valve core 30 and flow restriction member 22 and annular passage 26 so as to facilitate fluid flow from the second valve to this annular passage when the second valve is opened.

An outlet port 50 extends transversely from upper housing 12 and includes a channel that is in fluid communication with annular passage 26. The outlet port includes a connection member 52 that is connected in a fluid tight manner (e.g., via a threaded connection) with outlet port and that is configured to receive a sealing element 54. The sealing element includes an axially extending channel 55 that communicates with the outlet port when the sealing element is connected with connection member 52. The connection member includes a plurality of annular barbs or prongs extending from its exterior surface that engage with sealing element 54 when the sealing element is fit over the connection member so as to ensure a fluid tight seal is maintained at this connection.

The sealing element also has a generally conical configuration, with a taper or cross-sectional dimension that is reduced as the sealing element extends in a direction from its inlet end to its outlet end. In other words, the transverse cross-sectional geometry of the sealing element is generally round or in the shape of a circle, with each circular cross-section increasing from inlet to outlet of the sealing member. The tapering angle (i.e., the angle at which the sealing element outer wall sections diverge from a line parallel with the axially extending channel within the sealing member and tangent with the outlet end) is preferably no greater than about 10° (e.g., about 8° or less).

The sealing element can further include any suitable dimensions and be constructed of any suitable one or combination of plastic and/or elastomeric or rubber materials containing one or more polymers or copolymers. For example, the sealing element can be constructed of a variety of different elastomeric or rubber compounds including, without limitation, butyl polymers (e.g., polyisobutylene), butadiene copolymers such as acrylonitrile butadiene and styrene butadiene, epichlorohydrin polymers (e.g., polymers commercially available under the trademark HYDRIN), blends of epichlorohydrin and polyamide polymers. Preferably, the sealing element is constructed of any suitable elastomeric material having a Shore A hardness value in the range of about 30 to about 60, most preferably having a Shore A hardness of about 40.

Alternatively, or in addition to being constructed of elastomeric materials, the sealing element can be constructed of any one or more suitable hard plastic or metal materials. For example, the sealing element can be constructed of a hard plastic material such as acetal resins (e.g., acetal resins commercially available under the trademark DELRIN).

A button or actuator guard 60 is provided around actuator 42 so as to prevent inadvertent actuation of the actuator by a user (e.g., during movement of the regulator from one analyzer to another). The actuator guard is basically an elongated and generally cylindrical portion of upper housing 12 that extends around actuator 42 so as to guard or shield the actuator. In addition, the actuator guard includes a cut away or cut-out section 62 (see FIG. 2), where a portion of the cylindrical guard is removed. This cut-out section provides easy access to the actuator and is further aligned in a direction which opposes the regulator outlet, which is particularly useful for allowing a user to operate the actuator with a thumb without the inconvenience or difficulty of having to first navigate around or over the guard.

Operation of the regulator device with the improved features according to the invention is now described with reference to FIGS. 1-3. Initially, regulator device 2 is connected with a fluid supply source, typically a cylinder or vessel, at regulator inlet port 6, and the fluid cylinder is opened to facilitate fluid flow into channel 7 of lower housing 4. Pressure gauge 8 provides an indication to the user of the fluid pressure within the cylinder. Fluid flows within portions of the upper and lower housings of the regulator device as shown by the solid and dashed lines in FIG. 1. The regulating valve design within valve chamber ensures that fluid is delivered at a generally constant pressure to the second valve disposed in upper housing 12 regardless of the fluid pressure within the cylinder.

In particular, fluid flows from the cylinder into valve chamber 14, through inlets 19 and into channel 18 within movable member 16. When the fluid is at a higher pressure than the threshold regulator pressure, the fluid flows within channel 18 and into an upper end of valve chamber 14 (as shown by the dashed line in FIG. 1), where it contacts an upper end 21 of movable member 16 and forces the movable member downward toward lower housing 4 against the bias of spring 17. If the fluid pressure is significantly high, the movable member can be forced such that end cap 20 engages valve seat 10 to seal the regulator valve and prevent further fluid flow from the cylinder until the pressure is reduced within valve chamber 14. In addition, when the fluid pressure within the cylinder is less than the biasing force applied to the movable member by the spring, the movable member maintains its biased position within the valve chamber.

Fluid from the cylinder further flows around restrictor plug 25 and into channel 24 of restriction member 22 for delivery to the second valve member (as shown by the solid line in FIG. 1). The fluid is provided to the second valve member at a generally constant and desired pressure by operation of the regulator valve described above. The fluid is prevented from flowing further within upper housing 12 until the second valve is opened by user manipulation of actuation member 42. In particular, as can be seen in FIG. 3A, cup 38 and rubber member 39 are pressed against the lower end of valve core 30, due to the bias applied to pine 34 by spring 36, which prevents fluid from entering the second valve and flowing to regulator outlet 50.

When it is desirable to deliver a flow of fluid (e.g., a calibration gas) to an analyzer, the user inserts sealing member 54 into an inlet of the analyzer until a snug or frictional engagement is obtained, and the regulator is held with the sealing member in such position with the analyzer inlet. The sealing member provides a fluid tight engagement with the analyzer at the frictional engagement. This is particularly the case for an elastomeric sealing member, due to the resiliency and form fitting nature of the elastomeric material forming a snug and fluid tight fit within the analyzer inlet. In addition, the conical configuration of the sealing member allows the sealing member to achieve such a fluid tight engagement with a variety of different valve inlets of varying dimensions.

Upon insertion of the sealing member within the analyzer inlet, the user presses actuator 42 (e.g., with a thumb or forefinger), which forces pin 34 in a downward direction against the bias of spring 36 and toward the lower end of valve core 30 (as can be seen in FIG. 3B). The pressing of the actuator in this manner is easily facilitated by cut-out section 62 of actuator guard 60. The downward movement of the pin forces cup 38 and rubber member 39 away from the lower end of the valve core, allowing fluid to pass through the open lower end and into channel 32 (as shown by the solid line in FIG. 3B). The fluid flows through channel 32, out of the upper end of the valve core, and into fluid flow chamber 43. The fluid further flows between a small gap between outer wall surfaces of the upper end of flow restriction member 22 and inner wall surfaces of actuator 42, where it then flows into annular flow passage 26 and through outlet port 50 and sealing member channel 55 to the inlet of the analyzer.

When the actuator is disengaged by the user, pin 34 is forced by spring 36 back to its original position (as depicted in FIG. 3A) to once again seal the second valve. The user can then easily remove the sealing element from the analyzer inlet and move the regulator valve to another analyzer for injection of fluid from the cylinder.

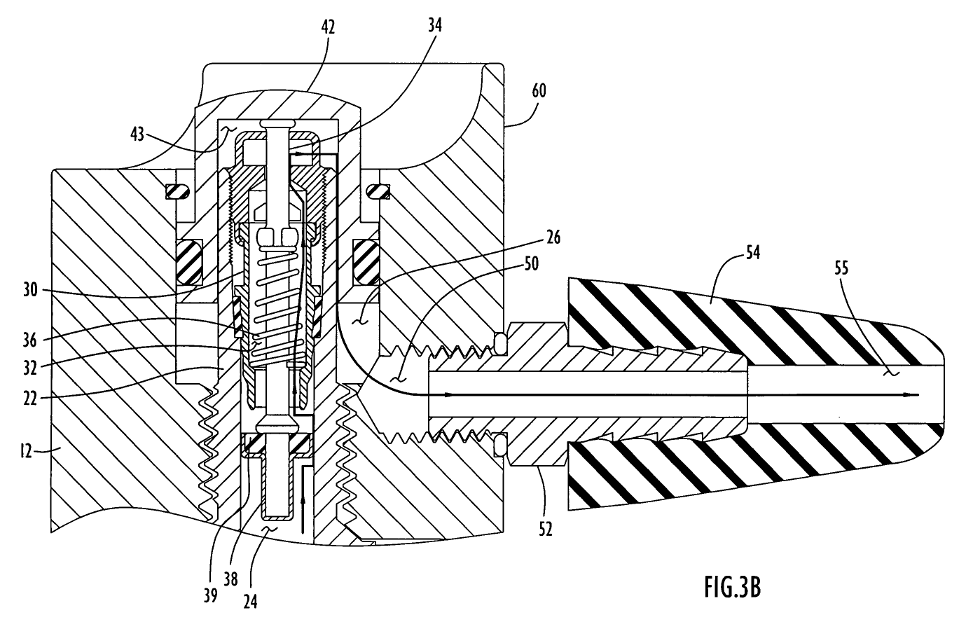

The sealing element that connects at the regulator outlet port is not limited to the configuration of FIGS. 1-3. Rather, the sealing element can include any suitable geometric configuration that facilitates easy and reliable fluid tight connections with analyzer inlets of varying shapes and sizes. For example, the sealing element can have an oval configuration as depicted in FIG. 4. In particular, sealing element 54′ has a transverse cross-sectional geometry that is oval in shape (rather than generally circular as in the embodiment depicted above), with the transverse cross-sectional dimension of the sealing element decreasing in a direction from the inlet to the outlet. A channel 55′ also extends through the sealing element to facilitate flow from the regulator outlet port to the analyzer inlet when the sealing element is connected with the analyzer inlet.

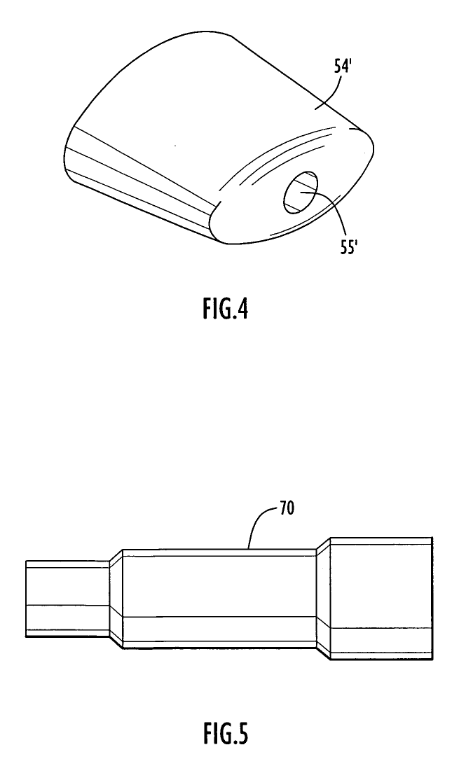

Another embodiment of the sealing element according to the invention is shown in FIG. 5. In this embodiment, sealing element 70 includes a series of stepped sections, where the stepped sections decrease in transverse cross-sectional dimension in a direction from the inlet to the outlet of the sealing element. A channel extends through and between the inlet and outlet ends of the sealing element. Each stepped section has a generally cylindrical geometry. However, it is noted that one or more of the stepped sections can also include a conical geometry (e.g., similar to the geometry of sealing element 54 depicted in the embodiment of FIGS. 1-3). One or more portions of sealing element 70 can be constructed of an elastomeric material (such as the types described above) and/or hard plastic (e.g., an acetal resin such as the type commercially available under the trademark DELRIN). For example, the outlet end of the sealing element can be constructed of a hard plastic (such as acetal resin), and the other portions of the sealing element can be constructed of elastomeric materials and/or hard plastic materials.

The sealing element of FIG. 5 has a suitable dimension that permits the outlet end of the sealing element (i.e., the portion of the sealing element with the smallest cross-sectional dimension) to activate a pressure sensor disposed within an analyzer when the sealing element engages with the inlet of the analyzer. By activating this pressure sensor, the analyzer is enabled for processing a fluid sample. Thus, the sealing element of FIG. 5 provides the additional feature of enabling operability of the analyzer to which it connects. In addition, the stepped design of the sealing element facilitates connection of the regulator device with a larger variety of analyzers with significantly varying inlet shapes and sizes (particularly when the stepped sections have conical geometries).

Thus, the regulator device with sealing element and cut-out actuator guard as described above provides significant advantages over conventional regulator devices. In particular, the regulator device with sealing element facilitates easy and quick insertion into a variety of different analyzers while maintaining a fluid tight connection between the regulator device and the analyzers. The plastic and/or elastomeric configuration of the sealing device provides an effective seal for different sized analyzer inlets or analyzer inlets that may be slightly deformed or “out of round” in design. In addition, the cut-out actuator guard provides additional ease of operation for the user during actuation of the second valve to inject fluid into an analyzer.

Having described a novel push button regulator device with sealing element to facilitate easy connection with other devices, it is believed that other modifications, variations and changes will be suggested to those skilled in the art in view of the teachings set forth herein. It is therefore to be understood that all such variations, modifications and changes are believed to fall within the scope of the present invention as defined by the appended claims.

1. A regulator device comprising:
a housing including an inlet that is securable to a fluid vessel so as to receive fluid within a channel of the housing from the fluid vessel and an outlet that delivers fluid from the regulator device;
a first valve member disposed within the housing that maintains the fluid pressure delivered from the fluid vessel to the housing outlet within a selected pressure range;
a second valve member disposed within the housing at a location between the first valve member and the housing outlet, wherein the second valve member includes a biasing member that biases the second valve member in a closed position to prevent fluid from flowing through the second valve member to the housing outlet;
an actuator that is selectively movable against the bias of the biasing member so as to open the second valve member and allow fluid to flow through the second valve member and to the housing outlet; and
a sealing element connected at the housing outlet and including a channel extending through the sealing element, wherein the sealing element has a transverse cross-sectional dimension that decreases from an inlet of the sealing element to an outlet of the sealing element.

2. The regulator device of claim 1, wherein the actuator is suitably dimensioned and aligned at an end of the housing so as to be movable by a thumb or finger of a user while the user holds the regulator device, and the regulator device further comprises:
a guard that extends around a peripheral portion of the actuator, wherein the guard includes a cut-out section to facilitate access to the actuator by insertion of the thumb or finger of the user through the cut-out section.

3. The regulator device of claim 1, wherein the sealing element has a conical geometry.

4. The regulator device of claim 1, wherein the transverse cross-sectional shape of the sealing element is circular.

5. The regulator device of claim 1, wherein the transverse cross-sectional shape of the sealing element is oval.

6. The regulator device of claim 1, wherein the sealing element includes at least a first section and a second section disposed between the first section and the outlet of the sealing element, and the second section is disposed adjacent the first section to form a stepped transition from the first section to the second section.

7. The regulator device of claim 1, wherein the sealing element comprises an elastomeric material having a Shore A hardness value in the range from about 30 to about 60.

8. A method of providing a test gas to an analyzer, the method comprising:
providing a regulator device including a housing, a first valve member and a second valve member disposed within the housing, the second valve member being disposed between the first valve member and an outlet of the housing, an actuator to control operation of the second valve member, and a sealing element connected at the housing outlet and including a channel extending through the sealing element, wherein the second valve member includes a biasing member that biases the second valve member in a closed position to prevent fluid from flowing through the second valve member to the housing outlet, and the sealing element has a transverse cross-sectional dimension that decreases from an inlet of the sealing element to an outlet of the sealing element;
securing an inlet of the regulator device to an outlet of a fluid vessel so as to facilitate fluid flow from the fluid vessel to a channel disposed within the housing of the regulator device;
maintaining the fluid pressure of fluid delivered from the fluid vessel to the housing outlet within a selected pressure range via the first valve member;
inserting the sealing element within an inlet of an analyzer to establish a fluid tight connection between the housing outlet of the regulator device and the analyzer inlet; and
manipulating the actuator to move against the bias of the biasing member so as to open the second valve member and to allow fluid to flow through the second valve member and to the housing outlet.

9. The method of claim 8, wherein the regulator device includes a guard that extends around a peripheral portion of the actuator, and the guard includes a cut-out section to facilitate access to the actuator by insertion of a thumb or finger of the user through the cut-out section when manipulating the actuator to open the second valve member.

10. The method of claim 8, wherein the sealing element has a conical geometry.

11. The method of claim 8, wherein the transverse cross-sectional shape of the sealing element is circular.

12. The method of claim 8, wherein the transverse cross-sectional shape of the sealing element is oval.

13. The method of claim 8, wherein the sealing element includes at least a first section and a second section disposed between the first section and the outlet of the sealing element, and the second section is disposed adjacent the first section to form a stepped transition from the first section to the second section.

14. The method of claim 8, wherein the sealing element comprises an elastomeric material having a Shore A hardness value in the range from about 30 to about 60.

15. A regulator device comprising:
a housing including an inlet that is securable to a fluid vessel so as to receive fluid within a channel of the housing from the fluid vessel and an outlet that delivers fluid from the regulator device;
a means for maintaining the fluid pressure delivered from the fluid vessel to the housing outlet within a selected pressure range;
a means for selectively controlling fluid flow to the housing outlet by manipulation of an actuator, wherein fluid only flows to the housing outlet upon manipulation of the actuator; and
a sealing element connected at the housing outlet and including a channel extending through the sealing element, wherein the sealing element has a transverse cross-sectional dimension that decreases from an inlet of the sealing element to an outlet of the sealing element.
